(19) United States
(12) Patent Application Publication
(10) Pub. No.: US 2008/0289542 A1
(43) Pub. Date: Nov. 27, 2008

(54) Hydraulic Binder

(75) Inventors: Suz-Chung Ko, Lenzburg (CH); Michael Adler, Murzelen (CH); Juraj Gebauer, Veltheim (CH)

Correspondence Address: CHAPMAN AND CUTLER, 111 WEST MONROE STREET, CHICAGO, IL, 60603, US

(73) Assignee: Holcim Ltd, Zurich (CH)

(21) Appl. No.: 11/547,586

(22) PCT Filed: Apr. 5, 2005
(86) PCT No.: PCT/IB2005/000877

§ 371 Date: Oct. 4, 2006

(30) Foreign Application Priority Data
Apr. 5, 2004 (AT) A600/2004

(51) Int. Cl. C04B 28/14; C04B 28/06; C04B 18/06

(52) U.S. Cl. 106/695; 106/782; 106/707

(57) ABSTRACT

In a hydraulic binder containing slags, aluminium-silicates and calcium sulphate, slag, in particular furnace slag, in amounts below 50% (w/w) as well as aluminium-silicates different from furnace slag, as for example flue-ash and natural aluminium-silicates, as for example basalt or andesite, in amounts of 5 to 75% (w/w) respectively related to the entire blend with the requirement that the stm of slag and aluminium-silicates is between 82 and 95.9% (w/w) and as one of the activators CaSO₄ in amounts between 4 and 15% (w/w) as essential components are present. Additionally alkali activators, in particular alkali hydroxides and/or carbonates of Na and/or K in amounts from 0.1 to 3% (w/w) are deployed.

The invention relates to a hydraulic binder containing slags, aluminium-silicates and calcium-sulphate.

The composition and production of super sulphated metallurgical cements is based on the addition of calcium-sulphate to the cement. According to the international organisation for standardisation (ISO) super sulphated cement is defined as a blend of at least 75% (w/w) hackled, granulated furnace slag, large additives of calcium-sulphate (>5% (w/w) SO₃) and at most 5% (w/w) slacked lime, portland-cement clinker or portland-cement.

For the production of super sulphated cement the granulated slag according to the German norm has to contain at least 13% (w/w) Al₂O₃ and has to correspond to the formula (CaO+MgO+Al₂O₃)/SiO₂>1.6. According to Keil an amount of 15 to 20% alumina slag with a minimal modulus of (CaO+CaS+0.5 MgO+Al₂O₃)/(SiO₂+MnO)>1.8 is preferred. According to Blondiau the CaO/SiO₂ ratio has to be between 1.45 and 1.54 and the Al₂O₃/SiO₂ ratio has to be between 1.8 and 1.9.

Lime, clinker or cement are added in order to increase the ph-value in the cement-paste and to enhance the solubility of alumina soil in the liquid phase during the hydratisation of the cement. The hardening of super sulphated metallurgical cement can take place without chemical additives or a specific formation treatment.

The U.S. Pat. No. 5,626,665 discloses a mixed puzzolana for use with portland-cement for the production of a cement like system. The mixed puzzolana contains burned clay and at least one component chosen from the group consisting of at about 2% to at about 30% hard plaster, at about 0% to at about 25% hydrated kiln dust, at about 0% to at about 20% hydrated lime, at about 0% to at about 20% hydrated lime kiln dust, at about 0% to at about 50% flue-ash and at about 0% to at about 5% organic plastificator. The burned lime is present in sufficient amounts in order to yield a mixed puzzolana with a final total weight of 100%. The mixed puzzolana is mixed with portland-cement in a weight-ratio of at about 1:20 to at about 1:1, preferably at about 1:2 to at about 1:3.

In normal portland-cements and metallurgical cements, in which the hydratisation takes place in the liquid phase free of solubilized alumina, the content of calcium-sulphate is restricted to a minor percentage in order to avoid a potential inner decay due to the formation of calcium-sulfo-aluminate (candlot bacilli) as a consequence of the non-solubilized alumina. In these cements the main influence of calcium-sulphate consists in the retarding action, which it excerpts on the setting time. The basicity of the hydrated calcium aluminates as well as the insolubility of the alumina contained in the aluminates depends on the lime concentration in the liquid phase of the cement and this independently from whether the hydrated calcium aluminates in the hardened cement are present in the crystalline form or in the amorphous form. The lime concentration in the liquid phase determines the kind of influence of the calcium-sulphate on the setting time of the cement and the maximal calcium-sulphate amount, which the cement can contain without resulting into inner decay to retarded formation of ettringite.

In super sulphated metallurgical cements the lime concentration in the liquid phase is below the limit of unsolubility of the alumina. Larger additions of calcium-sulphate for the activation of reactions of furnace slag determine the formation of tricalcium-sulfo-aluminate with higher hydraulic activity on the basis of the solubilized lime and the solubilized alumina without resulting in potential decay. The addition of calcium-sulphate to granulated furnace slag does not create expansion-cement but acts as accelerating agent in the formation of hydrated compounds. In super sulphated cement larger portions of calcium-sulphate are not to be considered as troublesome. The tricalcium-sulfo-aluminate, in which they result, in fact rather contribute to an increase of the hydraulic activity instead of causing decay, as it is the case for portland-cement and normal metallurgical cement.

The initial setting and hardening of super sulphated cement goes along with the formation of the high sulphate form of calcium-sulfo-aluminate from the slag components and the added calcium-sulphate. The addition of portland-cement to cement is required for the adjustment of the adequate alkalinity in order to allow for the formation of ettringite. The most important products of hydratisation are the mono- and trisulfo-aluminate-tobermorite-like phase and alumina.

Super sulphated cement in the course of the hydratisation binds to more water than portland-cement. It fulfils all requirements of the norm of cement as to the grinding fineness. It is considered as cement with low calorific value. As any portland- or metallurgical cement it can be used in form of concrete, setting mortar or groove mortar. The conditions to be considered for the use of super sulphated cement are identical with those that are decisive for the mixing and the application of other cements.

For the improvement of alumino silicate-binders it has already been suggested to activate them with alkali and in particular soda-brine or potassium hydroxide brine.

Alkali activated alumino silicate-binders (AAAS) are cement-like materials which are formed by reaction of fine silica-und alumina solids with an alkali- or alkali-salt solution for the production of gels and crystalline compounds. The technology of alkali activation was originally developed by Purdon from 1930 to 1940 who discovered that the addition of alkali to slag yields a rapidly hardening binder.

In contrary to super sulphated cement a large variety of materials (natural or burned lime, slag, flue-ash, belite alluvia, milled stone etc.) can be used as a source for alumino silicate-materials. Different alkali solutions can be used for the production of hardening reactions (alkali hydroxide, silicate, sulphate and carbonate etc.). That means that the sources for AAAS-binders are practically unlimited.

During the alkali activation a high concentration of OH-ions acts on the mixture of the alumino silicates. While in portland- or super sulphated cement-paste a pH>−12 is generated due to the solubility of calcium hydroxide, the pH-value in the AAAS-system is beyond 13.5. The amount of alkali, which is in general between 2 to 25% (w/w) alkali (>3% Na₂O), depends on the alkalinity of the alumino silicates.

The reactivity of an AAAS-binder depends on its chemical and mineral composition, the degree of vitrification and the grinding fineness. In general, AAAS-binders can begin to set within 15 min. and on the long run offer a quick hardening and a considerable increase in strength. The setting reaction and the process of hardening are still not completely understood. They go along with the initial leaching of alkali and the formation of slight crystalline calcium hydrosilicates of the tobermorite-group. Calcium-alumino silicates begin to crystallise to form zeolite-like products and consequently alkali-zeolite.

The strength values in the AAAS-system are contributed to the intense crystallisation contact between zeolites and calcium hydrosilicates. The hydraulic activity is improved by an increase of the alkali doses. The relation between the hydrauli activity and the amount of alkali as well as the presence of zeolite in the hydrated product has revealed that alkali not only act as simple catalyst but also participate in reactions in the same way as lime and hard plaster and feature a relatively high strength due to a considerable influence of cations.

In numerous studies concerning the activity of silico aluminate materials with alkali and their salts have been reported.

In the WO 00/00447 a super sulphated hydraulic binder has already been suggested in which calcium-sulphate in amounts of more than 5% (w/w) has been deployed. Along with aluminium-silicates under which in the definition of the WO 00/00447 also furnace slag has been subsumed, it was essential in the prior embodiment of the hydraulic binder that the cement kiln dust was added in amounts from 3 to 10% (w/w) as the activator. Additionally it was essential in this prior embodiment that at least 35% (w/w) furnace slag were deployed in order to be able to safeguard adequate strength values at an early stage. Over all, however, a relatively low strength at an early stage resulted with decreasing content of furnace slag, whereby at the same time due to the addition of cement kiln dust the water/cement factor rose and the hazard of shrinking and hence formation of cracks increased.

The invention thus aims to replace higher amounts of furnace slag by aluminium-silicates different from furnace slag as for example flue-ash and at the same time to achieve an improved strength at an early stage and an improved shrinking performance with a reduced tendency to the formation of cracks.

To solve this object the hydraulic binder according to the present invention generally consists in that slag and in particular furnace slag in amounts from 7 to 50% (w/w) as well as aluminium-silicates different from furnace slag, preferably flu-ash and natural aluminium-silicates, preferably basalt or andesite, in amounts from 5 to 75% (w/w) with the requirement that the sum of slag and aluminium-silicates is between 82 and 95.9% (w/w) and CaSO₄ in amounts between 4 and 15% (w/w) are present and that additionally alkali activators and in particular alkali hydroxide and/or carbonate of Na and/or K in amounts of 0.1 to 3% (w/w) are deployed. According to the invention the addition of cement kiln dust can be totally abandoned which is why the water/cement factor can be reduced and the risk of the formation of cracks can be minimized. A respectively smaller addition of an alkali activator leads to acutely favourable strength values at an early stage, whereby in the case of the use of cement kiln dust as alkali activator as well as in the case of other alkali activators the amount here is explicity confined to values under 3% (w/w) in order not to deteriorate the positive shrinking performance.

As setting accelerator advantageously also portland-cement clinker in amounts between 0.1 and 5% (w/w) can be deployed.

Over all it is feasible with the hydraulic binder according to the invention to essentially abandon CaO, so that the production of the binder becomes more environment-friendly because of the CO₂ emission being reduced by the abandonment of the burning of limestone. In a particularly advantageous manner, however, the mixture can contain limestone and/or sands or quartzes with the requirement that the Al₂O₃-content of the mixture is ≧5% (w/w).

Super liquefier or plastification agents respectively can be added for the improvement of the processability and/or for the reduction of the water/cement ratio in a conventional manner whereby preferably plastification agent and/or super liquefier is added to the binder in amounts from 0.1 to 1% (w/w) related to the dry substance for the reduction of the water/cement ratio.

Over all, by the feasibility to replace further furnace slag by aluminium-silicates different from furnace slag without abandonment of strength at an early stage, the possibility is opened up to improve the shrinking performance at an early stage and to reduce the water demand. The consequence is a reduced permeability and higher fatigue endurance.

In the following the invention will be explained by means of exemplary embodiments as listed in table 1. Table 1 at the same time shows also the respective strength values (CS) after one day, after two days and after 28 days.

| Example | | 1 | 2 | 3 |
|---|---|---|---|---|
| Furnace slag | % | 41.9 | 42 | 25.5 |
| Flue-ash | % | 41.9 | — | 58.65 |
| Andesite | % | — | 42 | |
| Anhydrite | % | 15 | 15 | 15 |
| KOH | % | 0.5 | 0.3 | 0.5 |
| Plastification agent | % | 0.7 | 0.7 | 0.7 |
| Water/cement | | 0.26 | 0.29 | 0.29 |
| CS 1 day | MPa | 13.2 | 10.9 | — |
| CS 2 days | MPa | 27.4 | 23.7 | 16.7 |
| CS 28 days | MPa | 97.4 | 61.3 | 46.1 |

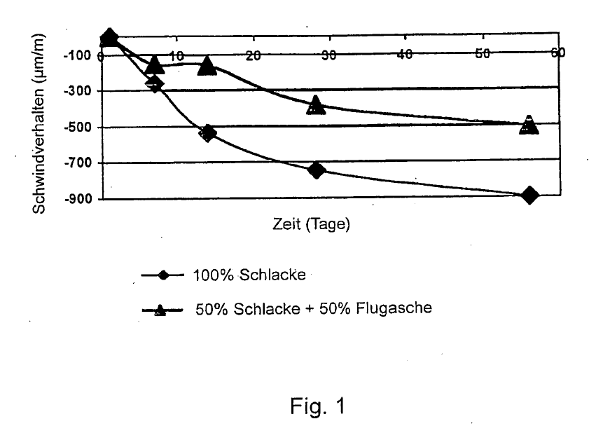

In FIG. 1 the shrinking performance of the binder according to the invention with at least partial replacement of the furnace slag by flu-ash can be seen and the resulting improvement is pointed out.

1. Hydraulic binder comprising slag, aluminium-silicates and calcium sulphate, wherein
the slag is provided in amounts from 7 to 50% (w/w);
the aluminium-silicates are different from furnace slag, and are provided in amounts of 5 to 75% (w/w);
the sum of the amounts of the slag and the aluminium-silicates is between 82 and 95.9% (w/w);
the calcium sulphate is provided in amounts between 4 and 15% (w/w); and
alkali activators are provided in amounts from 0.1 to 3% (w/w).

2. Hydraulic binder according to claim 1, wherein the slag is provided in amounts between 20 and 35% (w/w).

3. Hydraulic binder according to claim 1, further comprising one or more selected from the group consisting of limestone and quartzes, and wherein an Al₂0₃ content of the binder is greater than or equal to 5% (w/w).

4. Hydraulic binder according to claim 1, further comprising one or more selected from the group consisting of plastification agent and super liquefier, which are provided in amounts from 0.1 to 1% (w/w) related to dry substance in the binder.

5. Hydraulic binder according to claim 1, wherein portland-cement clinker is provided in amounts between 0.1 and 5% (w/w) as a setting accelerator.

6. Hydraulic binder according to claim 1, wherein the slag is furnace slag.

7. Hydraulic binder according to claim 1, wherein the aluminium-silicates are one or more selected from the group consisting of flue-ash, natural aluminium-silicates, basalt, and andesite.

8. Hydraulic binder according to claim 1, wherein the alkali activators are one or more selected from the group consisting of alkali hydroxides, carbonates of Na, and carbonates of K.

9. Hydraulic binder according to claim 2, further comprising one or more selected from the group consisting of limestone and quartzes, and wherein an Al₂0₃ content of the binder is greater than or equal to 5% (w/w).

10. Hydraulic binder according to claim 2, further comprising one or more selected from the group consisting of plastification agent and super liquefier, which are provided in amounts from 0.1 to 1% (w/w) related to dry substance in the binder.

11. Hydraulic binder according to claim 3, further comprising one or more selected from the group consisting of plastification agent and super liquefier, which are provided in amounts from 0.1 to 1% (w/w) related to dry substance in the binder.

12. Hydraulic binder according to claim 2, wherein portland-cement clinker is provided in amounts between 0.1 and 5% (w/w) as a setting accelerator.

13. Hydraulic binder according to claim 3, wherein portland-cement clinker is provided in amounts between 0.1 and 5% (w/w) as a setting accelerator.

14. Hydraulic binder according to claim 4, wherein portland-cement clinker is provided in amounts between 0.1 and 5% (w/w) as a setting accelerator.

15. Hydraulic binder according to claim 6, wherein the aluminium-silicates are one or more selected from the group consisting of flue-ash, natural aluminium-silicates, basalt, and andesite.

16. Hydraulic binder according to claim 15, wherein the alkali activators are one or more selected from the group consisting of alkali hydroxides, carbonates of Na, and carbonates of K.
